(19) United States
(12) Patent Application Publication
(10) Pub. No.: US 2002/0188927 A1
(43) Pub. Date: Dec. 12, 2002

(54) internet provided systems engineering tool business model

(76) Inventor: Laurence Bellagamba, Huntington Beach, CA (US)

Correspondence Address: Patent Counsel, TRW Inc., S&E Law Department, E2/6051, One Space Park, Redondo Beach, CA, 90278, US

(21) Appl. No.: 09/875,998

(22) Filed: Jun. 6, 2001

(51) Int. Cl. G06F 9/44

(52) U.S. Cl. 717/101; 717/106

(57) ABSTRACT

A software tool development system 100 is provided. The software tool development system 100 includes a customer 110 relaying tool requirements 113 to a tool provider 120 and a tool provider 120 generating a custom software tool 127 based on the tool requirements 113. The custom software tool 127 is then stored on a remote server 132 accessible by the customer 110. The users 116 at the customer 110 access the custom tool 134 and store data at the remote server 132. Additionally, when a user 116 completes a project element, the project element may be placed in a “to approve” database 138 at the remote server 132 for review by an approver 118 at the customer 110. Once a project element has been approved, the project element may be moved to a project database 139 at the remote server 132.

### BACKGROUND OF THE INVENTION

The present invention relates generally to a custom software tool development system. More specifically, the present invention relates to a custom software tool development system wherein a tool provider generates a custom software tool based on requirements received from a customer and stores the software tool on a remote, customer-accessible database.

Although the market for Application Service Providers (ASPs) is still in its infancy, the concept of an ASP is a powerful one. ASPs license, maintain, and rent software systems—such as accounting and human resource programs—typically written by other companies, for a broad range of business clients. More recently, Business Service Providers (BSPs) have appeared on the scene offering a suite of services for rent, often tailored to one industry, for example, airlines or banking.

ASPs may offer businesses significant savings in building and maintaining its own computational, storage, and software resources. For example, data generated using the software provided by the ASP may be stored remotely, thus reducing physical costs to the client. Additionally, support for the various software systems may be provided by the ASP, thus minimizing the client's need for on-site personnel to assist.

However, an ASP may be insufficient to service the software needs of a client that desires, or has business requiring, modifications to a software package or a customized software package. For example, in the high-tech area, project engineers may require access to physical and engineering simulation software system that is not currently in existence. The company employing the engineers is then typically forced to attempt to develop the software system in house, which may be quite expensive and time-intensive.

Although a BSP may customize software for an industry, for example, BSPs in the airline industry may include a ticketing application in their suite of services, such customization typically does not include customization on the application level. That is, BSPs do not customize their applications to the need of a specific client in response to client requirements.

In the high-tech area especially, much duplication of effort occurs between companies because many companies attempt to develop software systems in house on their own. Typically, the companies attempt to preserve the secrecy of their developmental efforts for several reasons including to maintain a competitive advantage in the marketplace by keeping secret the object of their efforts and the progress so far. However, such efforts come with the increased price of 1) engineering time to develop the application and 2) hardware, storage, and support assets to service the application.

Thus, a need has long been felt for a custom software tool development system for providing a customer with a software tool customized to the requirement of the individual customer. A need has especially been felt for such a tool development system that decreases engineering time and expense on the part of the client as well as decreases the hardware, storage, and support assets necessary by the client.

### SUMMARY OF THE INVENTION

The preferred embodiments of the present invention provide a custom software tool development system including a customer, a tool provider, and a remote server. The customer provides requirements for a custom software tool to the tool provider. The tool provider creates the tool and stores it on the remote server which is accessible by the customer. The customer accesses the custom software tool at the remote server and may also store data at the server. Once a user at the customer has completed a project element, the project element may be placed in an approval database at the remote server for review by an approver at the customer. Review and approved project elements may be stored in a project database at the remote server.

### BRIEF DESCRIPTION OF THE DRAWINGS

FIG. 1 illustrates a systems administration software tool development and access control system (software development system) according to preferred embodiment of the present invention.

### DETAILED DESCRIPTION OF THE PREFERRED EMBODIMENT

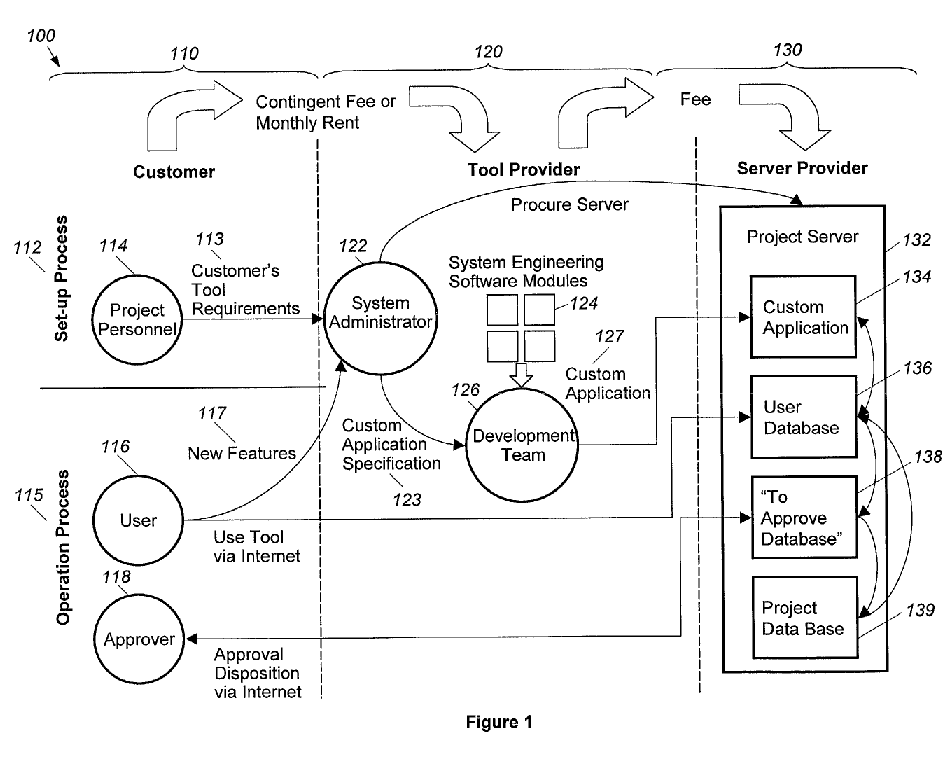

FIG. 1 illustrates a systems administration software tool development and access control system (software development system) 100 according to preferred embodiment of the present invention. The software development system 100 includes customer segment 110, a tool provider segment 120 and a server provider segment 130. The customer segment 110 includes a set-up process 112 involving project personnel 114 and customer tool requirements 113 as well as an operation process 115 including at least one user 116 and at least one approver 118 and new features 117. The tool provider segment 120 includes a system administrator 122, custom application specific tool requirements 123, system engineering modules 124, a development team 126, and a custom application 127. The server provider segment 130 includes a project server 132 including a custom application storage 134, a user database 136, a “to approve” database 138, and a project database 139.

In operation, the software development system 100 takes customer tool requirements, generates a custom application, and stores the custom application on a user-accessible server. The user may then access the custom application to perform developmental work which may be stored on the server. Additionally, individual project elements or decisions may be flagged for approval and may be placed in a separate approval database for review by authorizing agents.

First, during the set-up process 112, project personnel 114 of the customer 110 devise and compile tool requirements 113 for a potential tool desired by the customer 110. The tool requirements 113 are transmitted to the system administrator 122 of the tool provider 120. The system administrator 122 interprets the customer's 110 tool requirements 113 and translates the tool requirements 113 into tool requirements that are specific to the custom application to be produced. That is, the system administrator 112 projects the tool requirements into the functionality of the available system engineering software modules 124 to generate custom application specific tool requirements 123. The custom application specific tool requirements 123 are then relayed to the development team 126 of the tool provider 120. The development team 126 receives the custom application specific tool requirements 123 and then selects from among the available system engineering software modules 124 to compile a custom application 127 for the customer 110 in accordance with the custom application specific tool requirements 123. The development team 126 has access to a number of system engineering software modules 124. The system engineering software modules 124 are a number of software modules that enable project personnel 114 to: generate, manage, and communicate project requirements; analyze system effectiveness, cost development schedule and risks; and verify their product meets its requirements. These modules are integrated into a cohesive customer package or custom application 127.

The custom application 127 is then provided to the server provider 130. The server provider 130 controls a project server 132. The project server 132 is used to remotely host the custom application 127 devised by the development team 126. The server provider 130 may be any of a number of remote secure Internet service provider facilities. The custom application 134 stored on the project server 132 of the server provider 130 is then available for use by the customer 110 or any personnel of the customer 110.

Typically, the customer 110 may access the custom application 134 by going to a unique web address devised by the tool provider 120 in cooperation with the service provider 130. Once the customer 110 goes to the unique web address for the custom application of their project, the customer 110 typically enters a password provided by the tool provider 120 and gains access to the custom application 127 devised by the development team 126. Once the customer 110 has gained access to the custom application 134 on the remote project server 132, the customer's project development typically proceeds and is hosted by the project server 132. That is, the project server includes a user database 136, a “to approve” database 138, and a project database 140, each of which may be accessed by the customer 110.

In operation, once the customer 110 begins using the custom application 134 on the remote project server 132, user 116 generated data may be stored in the user database 136. The user database 136 may be a database that provides separate data storage for each user of the customer 110, for example, individual engineers or project teams. That is, the customer 110 may include a number of project development engineers or other software users that may wish to gain access to the custom application stored on the project server 132. Preferably each of these users is provided with unique storage in the user database 136. In operation, users 116 may access the custom application stored on the project server 132 of the service provider 130 via the Internet. The users 116 typically enter the custom application 134 via the user database 136. Once a user 116 has reached a certain level of development that requires approval of the user's supervisor or other engineering concern, the user may transport the project element needing approval to the “to approve” database 138.

Project elements stored on the “to approve” or approval database 138 may be accessed by the approver 118 of the customer 110. The approver 118 may make a decision at that point whether or not to approve the addition of the design element to the overall project. If the addition of the design element to the overall project is approved, the design element may be moved to the project database 140. The project database 140 is an additional database preferably stored at the project server 132 which includes limited access project elements. For example, the project database may include completed portions of the project that no longer require rework. Typically, and engineer may work on a project until the engineer is satisfied that the project is complete and without errors; the project may be relayed to the approval database 136 where the project may be reviewed by supervisor or quality control team for testing, analysis or confirmation; once the project has been confirmed, it may be placed in the project database 140 with other completed project elements.

Additionally, the user 116 or any number of users 116 of the customer 110 may discover as the project development proceeds that new features 117 are needed in the custom application 134 or that the customer's tool requirements 113 need to be revised. The user 116 may then communicate the new features 117 to the system administrator 122 of the tool provider 120. The system administrator 122 may then transmit the new features 117 or new requirements to the development team 126. The development team 126 may then review and revise the custom application 134. For example, the development team may include or customize additional software engineering modules or substitute software engineering modules for other software engineering modules to revise the custom application 134.

Two alternatives for compensation of the tool provider and service provider are available. The two options are a contingency fee option and a monthly rent option. In the contingency fee option, the tool provider 120 customizes the software, arranges for servers to be maintained by the service provider 130 and enables the use of the software for a specified time in exchange for promised payment for a specified time a contingent on provisions agreed to with the buyer. For example, the customer 110 may require the custom application for use in developing a proposal for a contract. The tool provider 120 may negotiate a contingency fee contingent upon the receipt of the contract by the customer 110. The second option is a monthly rent option. In the monthly rent option, the tool provider 120 customizes the software, arranges for the server 132 to be maintained by the service provider 130 and enables the use of the software for a negotiated period in exchange for a fixed fee.

Some of the advantages of the present invention include the following: first, integrated software for performing all major systems and varying tasks may be made accessible via the Internet to each and every user at the customer 110 simultaneously. This eliminates users having to wait for availability in a certain terminal or software. Second, the present invention vastly minimizes the learning time required to learn any new software package because each software package may be designed to have the same look and feel as specified by the customer. This may allow engineers to become quickly and easily familiar with new software packages and be able to complete project development in a much shorter time frame. Additionally, the present invention eliminates the cost to the customer 110 of having to maintain any sort of server to support their product development.

While particular elements, embodiments and applications of the present invention have been shown and described, it will be understood that the invention is not limited thereto since modifications may be made by those skilled in the art, particularly in light of the foregoing teachings. It is therefore contemplated by the appended claims to cover such modifications as incorporate those features which come within the spirit and scope of the invention.

What is claimed is:

1. A software tool development system including:
a customer relaying customer tool requirements for a tool to a tool provider;
a tool provider generating a custom tool based on the tool requirements received from the customer and storing the custom tool on a remote server accessible by the customer; and
a remote server accessible by the customer wherein said remote server includes:
a database storing the custom tool;
a database for storage by users of the customer; and
a project database.

2. The system of claim 1 wherein said tool provider includes a system administrator for interpreting the tool requirements received from the customer and generating custom application specific tool requirements.

3. The system of claim 2 wherein said tool provider includes a number of system engineering software modules.

4. The system of claim 3 wherein said tool provider includes a development team receiving said custom application specific tool requirements and said system engineering software modules and generating a custom tool.

5. The system of claim 1 wherein said remote server further includes a “to approve” database for storage of project elements awaiting approval.

6. The system of claim 5 further including an approver at the customer for reviewing project elements stored in said approval database.

7. The system of claim 1 wherein said customer determines new features and transmits said new features to said tool provider.

8. The system of claim 7 wherein said tool provider modifies said custom tool based on said new features.

9. A method for supporting customer development using a custom software tool including the steps of:
relaying customer tool requirements for a custom software tool to a tool provider;
generating, at a tool provider, a custom software tool based on the customer tool requirements;
storing said custom software tool on a remote server accessible by the customer; and
supporting customer development using said custom software tool by providing a database for storage by users of the customer and a project database for storage of competed project elements.

10. The method of claim 9 wherein said generating step includes the step of generating a custom software tool using a system administrator for interpreting the tool requirements received from the customer and generating custom application specific tool requirements.

11. The method of claim 10 wherein said generating step includes the step of generating a custom software tool using a number of system engineering software modules.

12. The method of claim 11 wherein said generating step includes the step of generating a custom software tool using a development team receiving said custom application specific tool requirements and said system engineering software modules and generating a custom software tool.

13. The method of claim 9 wherein said supporting step further includes the step of providing a “to approve” database for storage of project elements awaiting approval.

14. The method of claim 13 wherein said supporting step further includes the step of approving project elements stored in said approval database

15. The method of claim 9 further including the step of transmitting new features for said custom software tool from said customer to said tool provider.

16. The method of claim 15 further including the step of modifying said custom software tool at the tool provider in response to said new features.

17. A project server for use in a software tool development system, said project server including:
storage for a custom software tool developed by a tool provider in response to customer tool requirements supplied by a customer;
storage for user data developed through the use of said custom software tool;
storage for project elements awaiting approval; and
storage for completed project elements.

18. The system of claim 17 wherein said tool provider includes a system administrator for interpreting the tool requirements received from the customer and generating custom application specific tool requirements.

19. The system of claim 18 wherein said tool provider includes a number of system engineering software modules.

20. The system of claim 19 wherein said tool provider includes a development team receiving said custom application specific tool requirements and said system engineering software modules and generating a custom tool.

21. The system of claim 17 wherein said project elements awaiting approval are reviewed by an approver at the customer.
